(19) United States
(12) Patent Application Publication
(10) Pub. No.: US 2009/0250532 A1
(43) Pub. Date: Oct. 8, 2009

(54) Pneumatic device for the production of a sterilized spray partial vaporization

(76) Inventors: Alfonso Miguel Ganan Calvo, Sevilla (ES); Antonio Ojeda Monje, Sevilla (ES); Eladio Mendoza Simon, Sevilla (ES)

Correspondence Address: LADAS & PARRY LLP, 26 WEST 61ST STREET, NEW YORK, NY, 10023, US

(21) Appl. No.: 11/991,374

(22) PCT Filed: Sep. 15, 2006
(86) PCT No.: PCT/ES2006/000518

§ 371 Date: Apr. 1, 2009

(30) Foreign Application Priority Data
Sep. 23, 2005 (ES) P200502367

(51) Int. Cl. B05B 7/16; B05B 7/32

(52) U.S. Cl. 239/137; 122/400

(57) ABSTRACT

The object of the present invention is a device for the production of a sterilized spray, or limited in its potential microbial pathogen activity. Such spray is produced with a liquid, through the use of an impulsion steam that is obtained through the vaporization of part of such liquid stream to be atomized.

### AIM OF THE INVENTION

The object of this invention is a device for the production of a sterilized spray, or limited in its potential microbial pathogen activity. Such spray is produced with a liquid, through the use of an impulsion steam that is obtained through the vaporization of part of such liquid stream to be atomized. The device consists of a liquid reservoir, opened to the atmosphere or not; a feeding tube, which starts at the mentioned reservoir; and a liquid pump placed in the feeding tube to allow the extraction of the liquid. The feeding tube is bifurcated downstream of the liquid pump, giving rise to two lines: a steam production line and a liquid line; both lines have a valve to regulate the flow rate split between each line; the phase change takes place in the vaporization chamber, located in the steam production line; where there is a system to provide the heat (for example, an electric resistance). Optionally, the liquid line can have a heat exchanger to increase the temperature of the liquid without producing its vaporization. The ends of the steam line and the liquid line feed a head of mixing and atomization based in the generation of a free and unstable interface between both fluid streams. The spray produced in that head exit to the outer atmosphere for its use. The incorporation of thermal energy in, at least, the production of the steam phase, has a concomitant effect, limiting the presence of pathogen agents, and the energy can be controlled to ensure the partial or complete sterilization of the spray.

### INTRODUCTION TO THE STATE OF THE ART

The production of sprays from a liquid is part of many applications in all fields of activity. Particularly, in many of those applications, it is possible that there are presence of pathogen agents in the liquids, as it is the case of water or water-based solutions. For example, the humidifiers devices provide water steam to dry precincts aiming to increase their relative humidity and ensure the comfort of people. They are also used in industrial processes, where certain humidity is required, even requiring to saturate the environment, as it is the case of greenhouses.

On the other hand, there are some devices used to cool or acclimate precincts through evaporative cooling, that is, extracting heat from the environment through the evaporation of a liquid, generally water, that is in contact with the place to be climatized.

For those devices, there are several which are based in the generation of a spray that contacts the environment, so that the droplets produced evaporate. If such liquid is water, the achieved effect is to increase the relative humidity of the precinct (humidifiers) and cool the room (evaporative coolers). This later system is more and more often used because of its larger energy efficiency when compared with a conventional air conditioning system using a coolant and a compressor.

During the humidification process through the evaporation of the droplets of a spray, it is important that the size of the droplets is smaller than a certain critical value (that depends on the climate conditions but it is usually smaller than 50 microns) in order to ensure that they will stay in suspension in the environment and eventually evaporate. Otherwise, the droplets may not evaporate within the desired time and they may impact on close surfaces generating water deposition on them. The techniques to atomize liquids could be enumerated as centrifugal, through hydrostatic or hydrodynamic pressure, pneumatic, electrohydrodinamic and ultrasonic. In the pneumatic atomization a second fluid, generally a gas, is used to interact with the liquid transferring part of its energy. That energy is used in the production of new surface of liquid, that is, in breaking the liquid in droplets to create a spray. The pneumatic atomization generally obtains good performance with a moderate pressure.

Other techniques to humidify environments are based on the direct evaporation of the water and the introduction of the steam in the environment. There is also a system consisting on making an air stream go through a water curtain, transferring the humidity to the air stream.

In all these humidification systems, a liquid water reservoir is required to provide water to the humidity generation systems. The conditions in these water storing systems, aimed for humidification and other purposes, are very favourable for the apparition of colonies of pathogen bacteria, like the Legionella pneumophila. Because of that these humidification systems have sometimes been related with wide outbreak of legionnaire's disease.

There are methods to decontaminate these reservoirs of Legionella, mainly with strong chlorination of the water, although it can also be used as an alternative to preheat up to 71-77° C. There also several patents like the WO2005092473-A1 describing a filter made of materials treated with antimicrobial properties agents. The patent JP2004209395-A refers to a method in which several compounds are added to the water in order to eliminate microbes, as the Legionella. Lastly, in the patent US2003089651-A1, it is described a system that treats a water stream with a sterilizing ultraviolet ray unit, a device where the water is chemically modified and a mechanism that mix the water with steam, all of that in order to sterilize completely the water stream.

### DESCRIPTION OF THE INVENTION

The object of the present invention is a device for the pneumatic atomization of a liquid through the use of an impulsion steam, so that both fluids are expelled to the outer environment after its mixing. The liquid exits as an aerosol or suspension of droplets that is transported by the gas stream.

The device (see FIG. 1) consists of a liquid reservoir (1), open or not to the atmosphere; a feeding tube (2), that starts at the mentioned reservoir; a liquid pump (3) to extract the liquid, located in such feeding tube; downstream of the pump, the feeding tube is bifurcated in a T-shaped connector (4), giving rise to two lines: a steam production line (6) and a liquid line (5); both lines have valves or passive regulation elements (7) to ensure the flow rate split, so that the mass flow rate of liquid to be vaporized is between 0.01 and 0.99 times the total mass flow rate of liquid; the phase change in the steam production line happens in the vaporization chamber (8), where there is a system to add and receive heat (for example an electric resistance, or an area where the rays coming from a solar panel are collected; the two ends of the steam and liquid lines feed a head of mixing and atomization (10), based on the production of a free and unstable interface between two fluid streams; the spray obtained in such head exits to the outer environment to be used; the thermal energy supply in the vaporization chamber (8) and the flow rate of both phases can be controlled to satisfy the target of sterilizing partially or totally the produced spray.

Optionally, the device includes a heat exchanger (9) in the liquid line that increases the temperature of the liquid without reaching the evaporation.

### DESCRIPTION OF THE FIGURES

FIG. 1: drawing of the atomization device

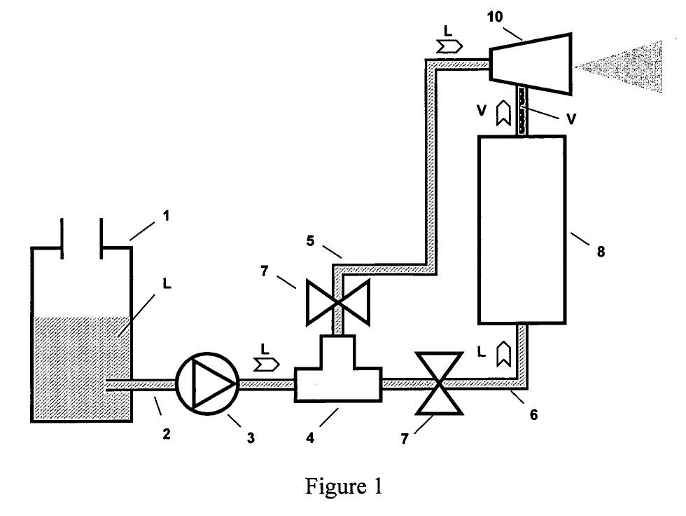

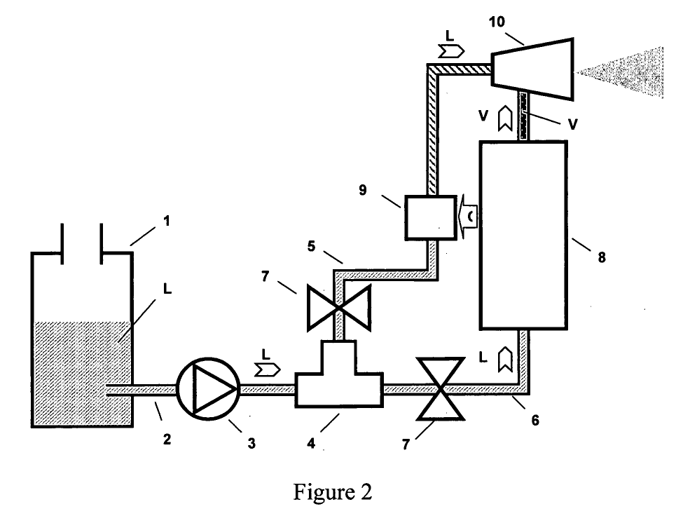

Figura 2: drawing of the atomization device including a heat exchanger in the liquid line

### FIGURES LABELS

1. liquid reservoir with the liquid to be atomized
2. feeding tube
3. liquid pump
4. T-shaped connector
5. liquid line
6. steam production line
7. flow rate regulation valves
8. vaporization chamber
9. heat exhanger (optional)
10. head of mixing and atomization

### DESCRIPTION OF THE INVENTION

The device object of the present invention consist on a pneumatic atomization head (10) where two streams converge, the liquid to be atomized (5) and the gas (6), that will be steam coming from a vaporizable liquid. To impel both streams into the head a liquid pump (3) is used. The flow rate provided by this pump is divided in a bifurcation (4). Part of it will be vaporized and the other part will be atomized. The flow rate split is controlled by passive elements of regulation (7). The flow rate intended to be atomized is conducted to the atomization head, meanwhile the other goes through a vaporization system (8) and, after that, to the atomization head. When the steam and the liquid get in contact in the atomization process, the liquid stream increases its temperature, producing a partial or total sterilization of the liquid. Therefore, with this system, based on ensuring the close contact between the liquid stream and the steam, at least during the instant of the liquid atomization, a double task of atomization and sterilization of the liquid is conducted.

The vaporization system functions continuously with a constant flow of water through the system, allowing to work in a continuous manner. To achieve it, a proper quantity of thermal energy must be provided to the system to vaporize such liquid flow rate.

One of the advantages of this atomization system as a humidifier is its smaller power consumption, especially during the starting phase of the device, when compared to other vaporization systems, in which the thermal power is provided to a whole volume of water in order to produce the complete evaporation of the water supplied to the environment.

As a contrast, the system presented by this invention only spend energy in vaporizing part of the water, furthermore using the vapor pressure of the produced steam to break the liquid stream into droplets. The rest of the liquid exits to the outer and completes its evaporation absorbing the required energy from the environment (hence cooling it). Therefore, the energy required by this device is much smaller than the one required by other humidification systems that produce the total evaporation of the water.

The advantages regarding the sterilization potential are intrinsic to the own system, since the use of steam as the feeding gas for a pneumatic atomizer, ensures that in the process of formation of droplets will exist an intimate contact between the liquid and the steam, leading to the sterilization of the liquid.

In case that this contact between the liquid and the steam during the atomization process was not enough to sterilize it, the system could be modified, including an exchanging system, so that some heat is transferred to the liquid line tube increasing the temperature of the liquid in order to reduce the microbial activity. As a last option, all the liquid flow rate could be injected in the vaporization chamber and extracting the liquid to be atomized from the bottom of the vaporization chamber and extracting the steam required for the pneumatic atomization from the upper part of the vaporization chamber. In this way, the liquid to be atomized reaches the vaporization temperature in equilibrium with its vapor, within the vaporization chamber, maximizing the liquid sterilization.

### EMBODYMENT OF THE INVENTION

An example of this invention can be made using water. To make a setup of the device a small scale system is made. It consists on a water tank (1). The water impulsion from the tank is made with volumetric micropumps (3) based on a diode that controls a small piston able to supply flow rates from 0 to 20 ml/min at pressures from 0 to 4 bars. The electric consumption of such pump is around 20 W. The hydraulic circuit of the system can be made with metal tubes, high temperature polymers or a combination of both, with internal diameters smaller than 1 mm. The hydraulic circuit consists on a mail tube (2) that divides in a bifurcation (4). The two tubes coming from the bifurcation contain the flow rates to be atomized (5) and vaporized (6). The flow rate control is made with needle valves (7). A percentage of the total water flow rate is continuously injected to a vaporization system (8) with a produced vapor pressure that is smaller than 4 bars, maintaining a continuous vaporization. The vaporization chamber (8) consists on a reservoir in which interior there is an electric resistance that is supplying thermal power to the water that is being vaporized. The volume of such chamber is of 8 cm³. The entry of the water to the vaporization chamber is placed in the bottom of the reservoir and the exit is placed in the upper part of the reservoir. The thermal power supplied by the vaporization chamber must be adjusted to the flow rate that is intended to be vaporized. The liquid flow rate is sent to atomization head to be atomized. A high efficiency pneumatic atomization head (10) is used to generate the spray.

The system described has been tested with a total flow rate of 10 ml/min. From that total flow rate, 3 ml/min are evaporated and the other part, 7 ml/min, is atomized (5). The thermal power used is around 100 W, coming from an electric resistance. In these conditions it can be obtained a spray with a droplet mean diameter smaller than 25 microns.

### Sterilization Effect

To study the sterilization effect that can be achieved with the device of the invention, some experimental tests have been carried out with Legionella pneumophila serogroup 1 including the following steps:
a) Preparation of the initial inoculant
   Inoculate 250 ml of sterile distilled water with a crop of 48-72 hours of L. pneumophila serogroup 1 ATCC in order to reach a turbidity equivalent to McFarland (Abs 0.08-0.10 at 620 nm).
b) Seeding the total volume recovered with a steam collector
   a. The total volume of the liquid at the exit is collected in a sterile container (approximately the 70% of the initial tank) by using a device to collect the water steam. Such device was designed and manufactures to collect all the atomized liquid exiting from the nebulizer through an surface of impact where the droplets are deposited and, after that, fall down by gravity to a lower container.
   b. It is filtered with a sterile nitrocellulose 0,2 μm filters by using a pressure pump.
   c. The filters are taken with sterile tweezers and they are introduced in containers with 10 ml of sterile water. They are vortex for 5 minutes.
   d. 10 ml of sample and 10 ml of an acid solution 0.2 M HCl/KCl pH 2.2 are mixed and vortex for 4 minutes
   e. The treated samples are diluted with sterile distilled water 1/10, 1/100, 1/1000, 1/10000.
   f. 100 μl of the directly treated samples and 100 μl of each dilution are seeded in 2 plates with BCYE and 2 plates with GVPC
c) Incubation and colony count
   a. All the inoculated plates are incubated at 36±1° C. during 10 days
   b. Countings are made at 5 and 7 days, making a preliminary identification with blood Agar and BCYE passing.
d) Comparation between the tank (control) and the exit of the atomizer (test)
   We compare the log10 disminution of viable colonies of Legionella at the exit of the atomizer with the count obtained in the tank, for each different seeding procedure. The results are summarized in the following table:

| | | Count (cfu/ml) | | | |
|---|---|---|---|---|---|
| | | 5 days | | 7 days | |
| | Diluted | GVPC | BCYE | GVPC | BCYE |
| Control | 10⁻³ | 3 × 10⁴ | 1 × 10⁴ | 3 × 10⁴ | 1 × 10⁴ |
| Test | Non-diluted | 0 | 0 | 0 | 0 |
| | 10⁻¹ | 0 | 0 | 0 | 0 |
| | 10⁻² | 0 | 0 | 0 | 0 |
| | 10⁻³ | 0 | 0 | 0 | 0 |

After 7 days none of the Legionella is recovered at the exit of the nebulizer in the test conditions

### INDUSTRIAL APPLICATION

The present invention has application in all those activities that require the generation of a spray from a liquid in which there may be presence of pathogen agents, microorganisms, etc.

The applications in the industrial field include all those processes where it is required the necessity of generating a spray from a liquid and where there is an available source of steam. In humidification processes, it is really advantageous because of its energy efficiency and its sterilization feature. In water purification it can be applied in any intermediate or final treatment to ensure the water sterilization.

It can be used in painting applications because the temperature of the steam affects the viscosity of the painting, leading to a finer atomization. In the fuel injection field, for example in gas boilers, the inner temperatures will be smaller, leading to the formation of the pollutant NOx, with formation reactions are governed by the temperature within the combustion chamber. It is especially interesting in vapor or combined cycles turbines, where the required steam for the atomization could be obtained from extractions of the last steps of the vapor turbine.

To reduce the pollutant NOx during the washing of gases in thermal stations, several equipments are used to atomize urea or water in order to be combined with this pollutant and reduce its concentration in the gas and pass to the mud. Again, the required vapor could be obtained from extractions of the last steps of the turbine at low pressures, so that the contribution of this steam to provide power is negligible and its use to decontaminate combustion gases is more suitable. Furthermore, by using pneumatic atomizers, instead of conventional showers, the droplet sizes are smaller. In such way, larger transference surfaces are obtained and then the size of the equipments for gas washing is reduced proportionally to the increase in the transference surface. If steam is used instead of air to assist the pneumatic atomizers within this purification of pollutant gases application, some water would be already being added as an agent to reduce the NOx.

1. Device for the pneumatic atomization of a liquid through the use of an impulsion steam, being both fluids expelled to the outer environment after their mixing; this mixing exits as an aerosol or suspension of droplets transported by the gas stream; the device consists of a liquid reservoir (1), open or not to the atmosphere; a feeding tube (2), that starts at the mentioned reservoir; a liquid pump (3) to extract the liquid, located in such feeding tube; downstream of the pump, the feeding tube is bifurcated in a connector (4), giving rise to two lines: a steam production line (6) and a liquid line (5); both lines have valves or passive regulation elements (7) to ensure the flow rate split, so that the mass flow rate of liquid to be vaporized is between 0.01 and 0.99 times the total mass flow rate of liquid; the phase change in the steam production line happens in the vaporization chamber (8), where there is a system to add and receive heat (for example an electric resistance, or an area where the rays of a solar collector are absorbed; the two ends of the steam and liquid lines feed a head of mixing and atomization (10), based on the production of a free and unstable interface between two fluid streams; the spray obtained in such head exits to the outer environment to be used; the thermal energy supply in the vaporization chamber (8) and the flow rate of both phases can be controlled to satisfy the target of sterilizing partially or totally the produced spray.

2. Device for the pneumatic atomization of a liquid according to claim 1, characterised by that the device includes a heat exchanger (9), located in the liquid line, that increases the temperature of the liquid without causing its evaporation.
